(19) United States
(12) Patent Application Publication
(10) Pub. No.: US 2007/0292484 A1
(43) Pub. Date: Dec. 20, 2007

(54) TREATED PIGSKIN PET TREAT

(75) Inventor: Mark Levin, Papillion, NE (US)

Correspondence Address: POLSINELLI SHALTON FLANIGAN SUELTHAUS PC, 700 W. 47TH STREET, SUITE 1000, KANSAS CITY, MO, 64112-1802, US

(73) Assignee: SERGEANT'S PET CARE PRODUCTS INC., Omaha, NE (US)

(21) Appl. No.: 11/425,069

(22) Filed: Jun. 19, 2006

(51) Int. Cl. A22C 13/00; A23K 1/165

(52) U.S. Cl. 424/442; 426/140

(57) ABSTRACT

The present invention relates to a pet treat having at least two distinctly treated pieces of pigskin and to a method of making it. In particular, the pet treat includes a piece of defatted pigskin and a piece of smoked pigskin.

### FIELD OF THE INVENTION

The present invention generally relates to a pet treat having at least two distinctly treated pieces of pigskin and to a method of making the pet treat. In particular, the pet treat includes a piece of defatted pigskin and a piece of smoked pigskin.

### BACKGROUND OF THE INVENTION

Pet chews and treats have generally been used to relieve the chewing urge of pets and/or to aid in the animal's dental hygiene. These pet treats have generally been produced from rawhide, a combination of rawhide and pigskin, or only from pigskin.

Rawhide is a hide or animal skin of buffalo, deer, elk, or cattle that has not been exposed to tanning. Generally, rawhide has been used for pet treats because dogs are attracted to its texture; however, treats that include only rawhide have a number of problems. One problem is that pets have a hard time digesting rawhide. As a pet breaks the rawhide into pieces and swallows them, the pieces can become lodged in the pet's digestive track causing medical problems to the pet. Another problem is that unflavored rawhide lacks attractive taste and smell to the pet. Rawhide treats soaked in a flavored solution, such as a flavored coating or gravy, basted or steeped in a flavored solution dried on the surface of the hides, although tastier to the pet, are not attractive to pet owners as the wet treats stain carpet and upholstery. In addition, once the animal licks off the flavoring, any future enticement to continue to chew the pet treat is gone and the pet treat may be ignored. Treats that include a combination of rawhide and pigskin although tastier because of the inclusion of pigskin still include the indigestible rawhide.

To address some of the problems of rawhide, manufacturers developed treats that include only the skin or hide of a pig or hog, as pigskin is more digestible and provides some nutritional value to the pet. Several methods have been used to make pigskin pet treats. One method includes placing a defatted, dehaired, and sanitized piece of pigskin in a smoker and smoking the pigskin with flavoring ingredients such as potato shreds, grain, rice, red granulated sugar, original sugar, yellow sugar, and pellet sugar. The flavoring ingredients infuse the pigskin providing it with an improved smell and color. A second method includes contacting a pigskin with an alkali and enzyme mixture to dissolve the colloidal protein of the pigskin, washing the skin in enzymes to soften and expand the skin, bleaching the skin with hydrogen peroxide or potassium permanganate, and forming the skin into a pet treat. A third method includes making a pig ear shaped pigskin pet treat. The method includes removing the hair and fat from the pigskin, dissolving the colloidal protein of the skin with an alkali and enzyme mixture, and folding the skin into a pig ear shape. The ear is then pressed in a hydraulic press, dried in an oven, and smoked in a conveyor smoking system with special mixture of ingredients such as rice stalks, wheat hulls, Chinese red sugar, and sweet potato strips. The smoked ear is then once again pressed in a hydraulic press, contacted with an antiseptic, and sterilized with ozone. The problem with these three methods is that the fatty, oily taste of the normal animal skin that entices the pet has been removed.

Therefore a need exists for pigskin pet treats that have an improved texture, are palatable, and healthy for the pet without the addition of rawhide.

### SUMMARY OF THE INVENTION

The present invention is directed to a treated pigskin pet treat having at least two distinctly treated pieces of pigskin. The present invention also includes methods for making the pet treat. The treated pigskin pet treat includes at least one piece of pigskin that has been defatted and texturized and at least one piece of pigskin that has been smoked.

The method of making the treated pigskin pet treat includes defatting a first piece of pigskin, smoking a second piece of pigskin, arranging the first and second pieces of pigskin in continuous contact with one another to form a shaped product, and drying the product to texturize the pet treat.

### DETAILED DESCRIPTION OF THE PREFERRED EMBODIMENTS

In accordance with the present invention, a process for forming a treated pigskin pet treat that includes two distinctly treated pieces of pigskin has been developed. Related to the process, the resultant treated pigskin pet treat having improved texture and palatability has also been discovered. The process includes treating one piece of pigskin to defat it and treating a second piece of pigskin to flavor it, arranging the two pieces of pigskin together to form a shaped product, and drying the product to form a treated pigskin pet treat.

The pigskin of the present invention can be derived from a boar, pig, or a hog. After the skin, or hide, is removed from the body of the pig or hog it is split into layers. The first layer is used to produce leather products and the other layers, leftovers, or scrapes of skin are generally disposed of. Although any part of the skin can be used in accordance with the invention, the preferred skins are the leftover layers or scrapes of pigskins.

The pigskin of the present invention may be fresh or preserved. Fresh pigskin has been recently removed from the pig and has not been subjected to additional processing, other than its removal from the pig. Preserved pigskin is skin that has been removed from the pig and preserved by drying or salting in order to prevent deterioration. Alternatively, the pigskin may be in various other stages of freshness or preservation.

The pigskin may be in the form of pieces, strips, sheets, or particles. In addition, the pieces, strips, sheets, or particles may be cut into any desired size to provide a pet treat of different shapes or configurations.

The first piece of pigskin is treated to produce a defatted piece of pigskin having a puffed texture and whitened color. The defatted pigskin is subjected to a dehairing, soaking, and cleansing process. Any process generally known in the art may be used to dehair, soak, and cleanse the first piece of pigskin. After the pigskin is cleaned, the pigskin is subjected to a defatting process. During the defatting process the pigskin is contacted with hydrogen peroxide to whiten the pigskin and remove at least a portion of the fat from the pigskin. The process also includes contacting the first pigskin with a sodium hydroxide solution to ensure that when the first pigskin is arranged in continuous contact with the second pigskin and dried to form a treated pigskin pet treat, the protein within the first pigskin denatures and air pockets form within the layers of the skin giving the first pigskin a puffed texture. In accordance with the present invention, other defatting methods generally known in the art may be used without departing from the scope of the invention.

Typically, the first piece of pigskin is contacted with hydrogen peroxide in a suitable vessel. The first piece of pigskin and the hydrogen peroxide is typically agitated in the vessel to allow the hydrogen peroxide to infuse into the pores of the pigskin. The pigskin is contacted with the hydrogen peroxide for between about 1 hours and 6 hours, preferably from about 2 hours to about 4 hours. Typically, the weight ratio of hydrogen peroxide to the first piece of pigskin by weight is 3:1. The pigskin is contacted with hydrogen peroxide to remove at least 50% by weight of the total fat present in the skin, preferably at least 80% by weight of the total fat present in the skin, more preferably at least 90% by weight of the total fat present in the skin.

In general, the first piece of pigskin is contacted with a solution of hydrogen peroxide and water. The strength or concentration of the hydrogen peroxide solution may vary depending on the desired texture of the pigskin or the amount of fat to be removed. The hydrogen peroxide solution may include from about 5% to about 50% by weight of the total solution hydrogen peroxide, preferably about 20% by weight of the total solution hydrogen peroxide.

After contact with hydrogen peroxide, the first piece of pigskin is then contacted with sodium hydroxide. Typically, the first piece of pigskin is contacted with sodium hydroxide in solution in a suitable vessel. The first piece of pigskin and the sodium hydroxide is typically agitated in the vessel to allow the sodium hydroxide to infuse into the pores of the pigskin. The pigskin is contacted with the sodium hydroxide for between about 30 minutes and 120 minutes, preferably from about 20 minutes to about 4 minutes. Generally, the first pigskin is contacted with a sodium hydroxide for a time sufficient to infuse the first pigskin so that when the first pigskin is heated, the protein within the pigskin denatures giving the first pigskin a puffed texture.

In general, the first piece of pigskin is contacted with a solution of sodium hydroxide and water. The strength or concentration of the sodium hydroxide solution may vary depending on the desired texture of the pigskin or the amount of fat to be removed. The sodium hydroxide solution may include from about 5% to about 50% by weight of sodium hydroxide, preferably about 40% sodium hydroxide.

The second piece of pigskin is treated to produce a piece of pigskin that is palatable and visually attractive to a pet. The second pigskin is subjected to a dehairing, soaking, and cleansing process. Alternatively, the second piece of pigskin may also be subjected to a defatting step, as described in detail above, to remove at least a portion of the fat present in the pigskin depending on the time of the year and season. After the second pigskin is cleaned it is then subjected to a smoking process to color and flavor the pigskin. A smoking process allows the flavorings to infuse the large pores of the second piece of pigskin. Any process generally known in the art may be used to smoke the second piece of pigskin, such as a grill, smoker, or smoke house. The pigskin may placed in a smoker rack with the flavorings placed below the pigskin, so that as the smoke rises and passes through the flavorings to the pigskin the palatability of the pigskin is improved. In addition, as the pigskin is smoked the color of the pigskin also changes. Alternatively, the pigskin may be coated with a flavoring and then placed in a smoker or grill so that the flavor is absorbed during the smoking process. Any flavoring that is attractive to a pet may be used. Suitable flavorings include natural flavors, artificial flavors, meat concentrates, dairy powders, dairy concentrates, fruit concentrates, vegetable powder, sweeteners, and mixtures thereof. Additional colorants may also be added to the pigskin, if desired, during the smoking process. Alternatively, a smoke flavor may be applied to the second piece of pigskin rather than subjecting the second pigskin to a smoking process.

The first and/or second piece of pigskin may also include herbal extracts for health benefits, enzymes for digestive disorders, vitamins for nutritional benefits, among others. Similarly, the pet treat of the present invention may also include other additives such as preservatives to improve the shelf-stability of the pet treat or an antimicrobial agent. Suitable preservatives include sodium benzoate, calcium propionate, and phosphoric acid.

After the first and second pieces of pigskin are treated, the first piece of pigskin is placed in continuous contact with the second piece of pigskin to form a shaped treat. Generally, the first and second pieces of pigskin may be arranged into various shapes, manually or mechanically. The first piece of pigskin may be placed on top of the second piece of pigskin and they may both be rolled together so that the first piece of pigskin forms an outer layer around the second piece of pigskin. The first piece of pigskin may also have cuts therein to allow the second piece of pigskin to protrude through the first piece of pigskin.

Alternatively, the first and second piece of pigskin may be interlayered together. In one embodiment, the first and second pieces of pigskin may be braided together and knotted at the ends to form a shaped treat. In another embodiment, a sheet of the first pigskin may be wrapped around a second piece of pigskin. In yet another embodiment, a piece of the second pigskin may be wrapped around a particle of the first pigskin. In a further embodiment, the first piece of pigskin may be rolled and a second piece of pigskin on top of the rolled first piece of pigskin. In addition, the pigskins may be in another shape other than sheet, strip, piece, or particle. For example, one of the pigskins may be a bar, stick, cylinder, or irregular shape. Alternatively, the positioning of the first and second pigskin may be reversed from that described above. For example, the first and second pieces of pigskin may be rolled together so that the second piece of pigskin forms an outer layer around the first piece of pigskin. The combined first and second pigskin may also be knotted to form a shaped treat. The combined pigskin may have at least one knot. Alternatively, the combined pigskin may have multiple knots. The knot may be on one end of the combined pigskin. Alternatively, the knot may be in the central portion of the combined pigskin. In another alternative, the combined pigskin may have two knots, each knot on opposing ends of the combined pigskin. In yet another alternative, the combined pigskin may have three knots, two knots on opposing ends of the combined pigskin and one in the central portion of the combined pigskin.

In addition, multiple pieces of pigskin may be defatted and wrapped around one or more smoked pigskin pieces. The resultant shaped treat has at least one defatted pigskin and at least one smoked pigskin, but is not limited thereto. The length of the pigskin treat may vary depending on the desired shape. Typically, a rolled pet treat, knotted at both ends may be from about 3 inches to about 12 inches in length.

After the first and second pieces of pigskin are arranged together to form a shaped treat, the treat is dried to form a treated pigskin pet treat. The drying process changes the texture of the first piece of pigskin. In particular, the pet treat is dried at a temperature and for a time sufficient for the infused hydrogen peroxide and sodium hydroxide to react with the first pigskin, denature the protein of the skin, and whiten and puff the skin changing its color and texture. In addition, the drying process also ensures that the shaped treat maintains its shape during shipment and storage.

Generally, the shaped treat is gradually heated to ensure that the pigskin is not cooked into gelatin. Typically, the drying process can last up to 2 days, heating the shaped treat at a very low temperature for a period of time and gradually increasing the temperature to achieve the desired textured pet treat. The shaped treat may be dried in one continuous conventional drier with multiple distinctly heated sections or in multiple distinctly heated conventional driers. The particular construction and configuration of the heating apparatus used is not critical in the practice of the present invention. The drying process temperature ranges from about 45° C. to about 85° C., more preferably from about 60° C. to about 70° C. Typically the treat is dried for between about 15 to about 24 hours. The pet treat is dried to a moisture content of less than about 12% by weight. The first piece of pigskin of the dried pet treat has a fat content of 3.5% by weight. The second piece pigskin of the dried pet treat has a fat content of 3.4% by weight.

The above description of the preferred embodiments is intended only to acquaint others skilled in the art with the invention, its principles, and its practical application, so that others skilled in the art may adapt and apply the invention in its numerous forms, as may be best suited to the requirements of a particular use. The present invention, therefore, is not limited to the above embodiments, and may be variously modified.

With reference to the use of the word(s) “comprise” or “comprises” or “comprising” in this specification (including the claims), Applicants note that unless the context requires otherwise, those words are used on the basis and clear understanding that they are to be interpreted inclusively, rather than exclusively, and that Applicants intend each of those words to be so interpreted in construing this specification (including the claims).

What is claimed is:

1. A process of making a treated pigskin pet treat, the process comprising:
a. defatting a first piece of pigskin to produce defatted pigskin;
b. smoking a second piece of pigskin to produce smoked pigskin;
c. arranging the first and second pieces of pigskin in continuous contact with one another to form a shaped treat; and,
d. drying the shaped treat to texturize the first piece of pigskin and form a treated pigskin pet treat.

2. The process of claim 1, wherein defatting the first piece of pigskin comprises:
a. subjecting the first piece of pigskin to a dehairing, cleaning, and sanitizing process;
b. contacting the sanitized first piece of pigskin with hydrogen peroxide; and,
c. contacting the first piece of pigskin with sodium hydroxide.

3. The process of claim 1, wherein smoking the second piece of pigskin comprises:
a. subjecting the second piece of pigskin to a dehairing, cleaning, and sanitizing process; and,
b. contacting the sanitized second piece of pigskin with flavorings.

4. The process of claim 3, wherein the second piece of pigskin is further contacted with hydrogen peroxide.

5. The process of claim 3, wherein the flavorings are selected from the group consisting of natural flavors, artificial flavors, smoke flavors, meat concentrates, dairy powders, dairy concentrates, fruit concentrates, vegetable concentrates, sweeteners, and mixtures thereof.

6. The process of claim 1, wherein the dried first piece of pigskin has a fat content of 3.5% by weight.

7. The process of claim 1, wherein the first piece and the second piece of pigskin is each selected from the group consisting of a sheet, strip, and a particle of pigskin.

8. The process of claim 1, wherein the second piece of pigskin is wrapped around the first piece of pigskin.

9. The process of claim 1, wherein the first piece and the second piece of pigskin are rolled together.

10. The process of claim 9, wherein at least one end of the rolled pet treat is knotted.

11. The process of claim 1, wherein arranging the first and second pieces of pigskin in continuous contact with one another to form a shaped treat comprises:
a. rolling the first piece of pigskin;
b. arranging the second piece of pigskin on top of the rolled first piece of pigskin to form a combined rolled pigskin; and,
c. forming at least one knot in the combined rolled pigskin.

12. The process of claim 11, wherein the knot is on one end of the combined rolled pigskin.

13. The process of claim 11, wherein the knot is in the central portion of the combined rolled pigskin.

14. The process of claim 11, wherein the pigskin has two knots and each knot is on opposing ends of the combined rolled pigskin.

15. The process of claim 1, further comprising contacting the pet treat with an additive selected from the group consisting of an antimicrobial agent, a preservative, and a colorant.

16. The process of claim 1, further comprising repeating steps (a) and (b) with a third and fourth piece of pigskin and arranging the third and fourth piece of pigskin in continuous contact with the pet treat.

17. The process of claim 1, wherein the pet treat is dried to a moisture content of less than about 12% by weight.

18. A treated pigskin pet treat, the pet treat comprising:
a. a first piece of dried defatted pigskin, wherein the dried first piece of pigskin has a fat content of 3.5% by weight; and
b. a second piece of dried smoked pigskin, wherein the first piece of dried defatted pigskin and the second piece of dried smoked pigskin are arranged in continuous contact with one another to form a treated pigskin pet treat having a moisture content of less than about 12% by weight.

19. The pet treat of claim 18, wherein the first piece and the second pieces of pigskins are interlayered together.

20. The pet treat of claim 18, wherein the first layer of pigskin is wrapped around the second piece of pigskin.

21. The pet treat of claim 18, wherein the first piece and the second piece of pigskin are rolled together.

22. The pet treat of claim 22, wherein at least one end of the rolled pet treat is knotted.

23. The pet treat of claim 18, wherein the first piece of pigskin is braided with the second piece of pigskin.

24. The pet treat of claim 18, wherein the first piece of pigskin is rolled, the second piece of pigskin is on top of the rolled first piece of pigskin to form a combined rolled pigskin, and having at least one knot in the combined rolled pigskin.

25. The pet treat of claim 18, further comprising an additive selected from the group consisting of an antimicrobial agent, a preservative, and a colorant.

26. The pet treat of claim 18, wherein the second piece of dried smoked pigskin is flavored with flavorings selected from the group consisting of natural flavors, artificial flavors, smoke flavors, meat concentrates, dairy powders, dairy concentrates, fruit concentrates, vegetable concentrates, sweeteners, and mixtures thereof.
